(19) United States
(12) Patent Application Publication
(10) Pub. No.: US 2026/0320928 A1
(43) Pub. Date: Oct. 15, 2026

(54) Aligning 3D Image Data Using Anatomical Structure of a Person

(71) Applicant: Novarad Corporation, Provo, UT (US)

(72) Inventors: Wendell Arlen Gibby, Mapleton, UT (US); Steven Todd Cvetko, Draper, UT (US)

(21) Appl. No.: 19/176,094

(22) Filed: Apr. 10, 2025

(51) Int. Cl. G06T 19/00; G06T 19/20; G06V 10/24

(52) U.S. Cl. CPC G06T 19/006; G06T 19/20; G06V 10/245; G06T 2219/2004; G06V 2201/07

(57) ABSTRACT

Technology is described for aligning the 3D image data with anatomy of the person. The method can include aligning a fluoroscopic image of an anatomical structure using an image visible marker on a person. Another operation may be displaying a slice of a 3D image data substantially parallel to the fluoroscopic image. Adjustments to the slice may be received until an internally identifiable portion of anatomical structure in the slice aligns with an internally identifiable portion of the anatomical structure in the fluoroscopic image as visualized on a display device.

### BACKGROUND

Mixed or augmented reality is an area of computing technology where views from the physical world and images from virtual computing worlds may be combined into a mixed reality view for a user. In mixed reality, people, places, and objects from the physical world and virtual worlds become a blended visual and audio environment. A mixed reality experience may be provided through commercial or custom software along with the use of VR (virtual reality) or AR (augmented reality) headsets.

Augmented reality (AR) is an example of mixed reality where a live direct view (or an indirect view) of a physical, real-world environment is augmented or supplemented by computer-generated sensory input such as sound, video, graphics or other data. Augmentation is performed as a real-world location is viewed and in context with environmental elements. With the help of AR technology (e.g. adding computer vision and object recognition) the information about the surrounding real world of the user may become interactive and may be digitally modified.

### BRIEF DESCRIPTION OF THE DRAWINGS

FIG. 1 illustrates an example of a fluoroscopic image that may be captured using a fluoroscopic imaging device in a room where a procedure is to be performed.

FIG. 2 illustrates an example of a fluoroscopic image of an anatomical structure that may be aligned using a first image visible marker on the person and a CT scan aligned with the fluoroscopic image.

FIG. 3 illustrates an example of aligning of a fluoroscopic image and portions of a 3D image set with a body of a person.

FIG. 4A illustrates an example of a fluoroscopic image and a CT scan that are aligned using an internally identifiable portion of anatomical structure in a slice of the CT scan that aligns with an internally identifiable portion of the anatomical structure in the fluoroscopic image.

FIG. 4B illustrates a body of a cadaver with at least two image visible markers fixed into the spine which a user may capture in at least two fluoroscopic images at separate angles.

FIG. 5A illustrates an example a fluoroscopic image taken from a first position for a simulated anatomical object.

FIG. 5B illustrates an example of a fluoroscopic image taken from a second position for a simulated anatomical object in FIG. 5A.

FIG. 6 illustrates an example of first fluoroscopic image and second fluoroscopic image taken from separate angles that may intersect.

FIG. 7 illustrates an example of a fluoroscopic image where machine learning may be used to identify an anatomical landmark in the fluoroscopic image
provide adjustments to a slice of the 3D image data until it aligns with internally identifiable portions of anatomical structure shown in a fluoroscopic image.

FIG. 8 illustrates an example of anatomical landmarks in a lateral fluoroscopic image that may be identified using machine learning.

FIG. 9 is a flowchart illustrating a method for aligning the 3D image data with anatomy of the person using adjustments received to a slice of 3D image data.

FIG. 10 is an example flowchart illustrating a method for aligning a 3D image data set with an anatomical structure of a person.

FIG. 11 is a block diagram that provides an example illustration of a computing device that may be employed in the present technology.

### DETAILED DESCRIPTION OF THE PREFERRED EMBODIMENTS

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The ability to align a 3D image data or a medical image with a person or patient using a wearable display or an AR headset can be valuable because the 3D image data or image data set (e.g., a CT scan or MRI (Magnetic Resonance Image)) can be used to guide a user or a medical professional during a medical procedure and a virtual overlay can be used to view highly detailed representations of the internal anatomy of the patient as visually overlaid on the patient during the medical procedure.

Quickly and conveniently aligning the 3D image data to the person with a high level of accuracy can be challenging. Some previous alignment methods do not provide enough accuracy while other can be less convenient and complex to implement. For example, a medical professional may try to align 3D image data with a person by hand by moving or adjusting the 3D image data to align with the person using the user interface of the AR headset. However, simply hand adjusting the 3D image data set can be quite difficult when there are three or six degrees of freedom for movement (i.e., 3 linear translation degrees of freedom and the 3 rotational axes degrees of freedom) of the 3D image data. Hand adjustments from one perspective can create problems for correct alignment from a different perspective.

In further similar example, a medical professional may take 3D image data and generally move the 3D image data onto the patient. Then the medical professional may move the 3D image data set to align the 3D data set from the one perspective. At that point, the 3D image data may appear to be aligned from the first view the medical professional is using (e.g., where the medical professional is located with an AR headset, on a 2D screen, etc.). However, as soon at the medical professional moves to another angle, then the 3D data set may not appear lined up with the person or the anatomical structure from the additional angle. This may occur because it can be difficult for the user to determine alignment in the depth direction from an initial perspective (the Z-axis from that single perspective). Then the user may try to align the 3D data set from a second perspective. However, when the user is aligning the 3D image data from the second view it can be difficult for the user to determine the depth of the 3D image data in the second view. As a result, the user may introduce errors into the alignment made from the first view point because it is difficult for the user to determine the depth at which the 3D image data is located from the second view point.

Another specific issue with receiving user input to hand align the 3D image data with an anatomical structure of a person is that the 3D image is a projected image in the AR headset and the brighter light from the projected image can obscure the anatomical structure of the person that the user wants to align with. For example, the user may see the 3D image data through the AR headset and use their hand to move the 3D image data onto the body of the person. However, the bright 3D image data may obscure part or all of the anatomical structure of the person which may make alignment to the anatomical structure or body difficult when the area to be aligned with is covered or washed out by the brighter 3D image data.

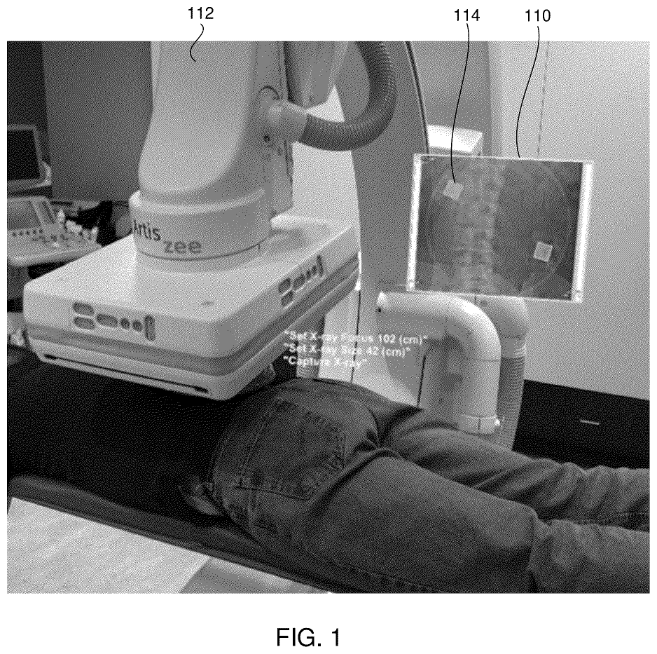

This technology may provide a method and system for aligning 3D image data with an anatomical structure of a person (e.g., a patient in a medical procedure). FIG. 1 illustrates an example of a fluoroscopic image 110 which may be captured using a fluoroscopic imaging device 112 in a room where a procedure is to be performed. The fluoroscopic image 110 may be shown to the user (e.g., a doctor) through an AR headset or wearable display with a pair of optical tags 114 that have an image visible tag component. For example, in this case the entire optical tag may be radiopaque but the optical tag or optical code may be formed in radiopaque material and may be visible to and registerable by the AR headset. The fluoroscopic image 110 may be shown to the user in FIG. 1 for reference but the fluoroscopic image 110 shown to the user may not be aligned with the body of the person at this point.

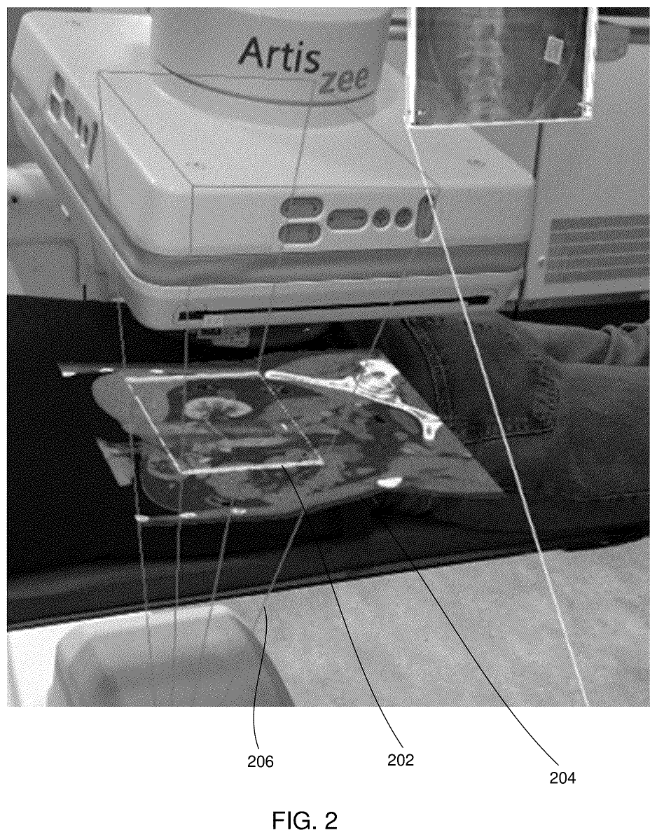

FIG. 2 further illustrates that a fluoroscopic image 202 of an anatomical structure of the body of the person may be aligned using an optical code and/or image visible marker on the person. In other words, the fluoroscopic image 202 may capture an optical code with an image visible marker (e.g., a radiopaque marker) in the fluoroscopic image and then the fluoroscopic image can be aligned with the body of the person or patient using position of the optical code and/or image visible marker.

A slice 204 of the 3D image data may be created to be parallel to the fluoroscopic image 202. Adjustments can be received to the slice 204 until an internally identifiable portion of anatomical structure in the slice 204 aligns with an internally identifiable portion of the anatomical structure in the fluoroscopic image 202. These adjustments can be displayed as visualized on a display device, in order to align the 3D image data with anatomy of the person. The display device may be a wearable display device, an AR headset, a VR headset, a 2D display (e.g., an LED display) or another display for visualizing the 3D image data set. The slice 204 of the 3D image data may be obtained by obtaining a projection of the 3D image data set captured prior to a medical procedure for the person. This projection may resemble the fluoroscopic image but the slice is created by taking a projection from the 3D image data. The term internally identifiable portion of the anatomical structure may include anatomy that within a person's body that is not visible.

In one embodiment, machine learning, pattern recognition or edge detection may identify anatomical structures (e.g., vertebral bodies) in the fluoroscopic image 202 or FIG. 2 and the slice of the 3D image data (e.g., CT scan). This allows the fluoroscopic image 202 to be aligned with the slice of the 3D image data 204. The fluoroscopic image 202 is somewhere between the source and the detector, as illustrated by the cone 206 virtually representing where the path the x-rays may be traveling to create the fluoroscopic image 202. However, the exact depth of the fluoroscopic image 202 is not known from the fluoroscopic image 202 alone. To be able to align the depth of the fluoroscopic image 202, an alignment can be performed in additional axis.

The fluoroscopic image 202 may be captured using x-rays emitted in a first axis. Adjustments to the slice may be received that are orthogonal to the first axis. The system may limit movement of the slice with respect to the first axis so that the adjustments received may not be in the depth axis as compared to direction of the x-rays used to capture the fluoroscopic image. In one example, the adjustments may be received from a doctor who is aligning the slice of the 3D data set with the fluoroscopic image. The doctor may send adjustments through a user interface until the doctor can see that internal anatomical structure of the slice of the 3D data set is aligned with the internal anatomical structure of the fluoroscopic image. The adjustments to the slice may then be applied to the entire 3D image data.

In a more specific example, a patient may have 3D image data captured of their body at an earlier time prior to a medical procedure. The 3D image data may be a CT scan or an MRI. When the patient is in the room where the procedure is going to take place, a medical professional can capture a first fluoroscopic image. This first fluoroscopic image may be an Anterior-Posterior fluoroscopic image (e.g., an AP x-ray projection). A second or additional fluoroscopic image may be captured that is a lateral fluoroscopic image (e.g., x-ray). Each fluoroscopic image (e.g., X-ray) can be aligned to the patient because of a radiopaque tag or a metal tag with an optical code on the patent that is captured in the fluoroscopic image so the fluoroscopic image can be aligned precisely to the patient. Then the medical professional can place the 3D image data on the patient.

In order to line up the 3D image data, the medical professional can align a slice or first projection of the 3D image data to anatomical structure in the first fluoroscopic image taken from a first angle or using a first axis (i.e., the axis of the x-rays). This alignment between slice and the fluoroscopic image can provide alignment in X and Y directions in a plane orthogonal to the direction of the x-rays. The medical professional can then align a second slice or projection of the 3D image data with the second fluoroscopic image taken from a non-parallel angle to the first fluoroscopic image. This second alignment can provide alignment in a Z direction or a depth direction as compared to the originally selected X and Y directions. These two alignments enable alignment of the 3D data set with the patient that was obtained pre-operatively and was not registered on the patient when they did the pre-operative CT scan. The projection or a slice of the 3D data set can be viewed as being substantially parallel to the fluoroscopic image when the internal anatomical structures of the slice are being aligned with the internal anatomical structures of the fluoroscopic image.

The instructions received for aligning the 3D image data with the fluoroscopic image can be received from a physician through a user interface to align the 3D image data manually. For example, the physician may move the slice of the 3D data set in the X and Y axes of the slice by providing numerical movement values, using keyboard input, using audible commands, using hand gestures in an AR headset or by dragging the 3D image data set in the X and Y directions using a pointing device in windowed operating system. This configuration may not use AI or data fitting. Accordingly, slices from the 3D data set can be visually aligned with the fluoroscopic images projected on the patient. If this alignment is performed in at least two non-parallel views of the fluoroscopic images, then the 3D data set can be aligned in three dimensions. The goal is to obtain alignment in three axes. Thus, a first alignment may provide alignment in two axes (e.g., X and Y directions for the images) and then the second alignment may provide alignment in a depth direction. Alternatively, a single axis at a time may be aligned with the same result.

In one example, a doctor can take an AP fluoroscopic image and a lateral fluoroscopic image that each contain a metal tag (that also include a visible marker for an AR headset). This provides at least two different angles for the fluoroscopic images to use for co-registration with slices of the 3D image data.

In an alternative example, a single AP fluoroscopic image can be aligned with a single visible marker or tag on the front of the patient that also includes an image visible marker (e.g., a radiopaque element). Then a CT scan that was obtained pre-operatively can be aligned with the AP fluoroscopic image. To obtain a depth alignment in this embodiment, a silhouette registration or matching the of a slice of the 3D data set morphometrically to a body of a person (e.g., using a lateral view of the patient through the AR headset) can provide an alignment in the Z-axis for the 3D data set. The X and Y alignment can come from the metal tags. This process can accurately register a 3D data set (e.g., a CT scan or MRI) with an anatomical structure (e.g., the spine) with a single image visible tag that has an optical code for an AR headset to view.

In another embodiment, fluoroscopic images can be taken of the patient from three angles. These fluoroscopic images might be three orthogonal views. This allows a doctor to look at the patient from three different planes. The degrees of freedom in each alignment view may be reduced to one or two degrees of freedom. Then a slice of the 3D data set may be aligned with a fluoroscopic image for each of the 3 orthogonal views.

The alignment process may also use shapes, borders or segments of the internal anatomy of the body of the person (i.e., patient) that are visible in fluoroscopic images of a patient captured in an operating room, which can be matched up with corresponding elements of internal anatomy (i.e., anatomy that is common to both images) in a slice of a CT image. For example, bones in a fluoroscopic image can be aligned to the same bones of the person in a CT image using dragging and/or rotation. As discussed, this may use at least 2 X-ray views where each X-ray is two-dimensional. As a result, a segment, element, or silhouette of a piece of anatomy in a CT scan or MRI can be aligned to a segment, element, or silhouette of a piece of anatomy in an X-ray which can align the CT scan to the body of the person.

A slice of the 3D image data orthogonal to an axis may be identified using the pre-defined axes. The slice selected may be along an axis that is selected from the pre-defined axes. For example, the pre-defined axes of the 3D image data set may be the sagittal, axial, and coronal axes of a person's anatomy in the 3D image data. Other medical axes of the person's body can also be used such as the transverse axis or plane, frontal axis (similar to axial) or plane, longitudinal axis, oblique axes, etc. depending on the desired axes or planes to be used and/or the anatomical structure being viewed. The technology may present views of the anatomy in three different orthogonal axes.

Using defined axes or the medically defined axes of a person's body, the technology can enable a slice to be restricted in movement or locked on the selected axis and adjusted in the remaining orthogonal axes to the selected axis where the image is locked. Other axes that are not well known medical axes can be selected (e.g., a selected oblique axis) and these axes may be orthogonal to each other for use in the present technology. For example, the slice of the 3D image data may be sliced orthogonal to the selected axis and then the slice on the axis can be locked to not move in the depth axis in the user's current perspective. A slice may be one or a few voxels wide from the 3D image data. The 3D image data and slice may be direct volume rendered and/or represent a 3D volume of anatomy scanned by a medical imaging device. In addition, the 3D image data may be a computed tomography (CT) scan or MRI (magnetic resonance imaging) image.

A slice of the 3D image data may be automatically identified that has a probability of matching the anatomical structure of the person viewed through the AR headset, as detected from a position of the AR headset or as viewed in a fluoroscopic image. The slice selected may be selected using AI or machine learning. Rule based implementations or pattern matching may also be used to select the slice. For example, a slice automatically selected may be anatomical structure in the 3D image data or image data set that has a widest diameter (widest diameter of the head, heart, torso or kidney) of the anatomical structure orthogonal to the axis of the 3D image data. In another example, a slice may be automatically selected that has a greatest total cross sectional area of the anatomical structure being selected (e.g., the nose on the head, the hand, the arm, the bone, etc.). In yet another example, a process may pick the slice with maximum extension from a cylindrical area of the anatomical structure (e.g., a nose from head, a widest or fattest part of the body, etc.). In another example, a slice may be selected because it is similar to the fluoroscopic image.

When selecting a slice, the user may want to select a slice where that anatomical structure being aligned is the widest or thickest because the 3D image data may be projected over the anatomical structure. The user may not be able to see anatomical structure that is covered by the projected 3D image data in the AR headset but having a wide slice may assist with better silhouette alignment, when that alignment process is used.

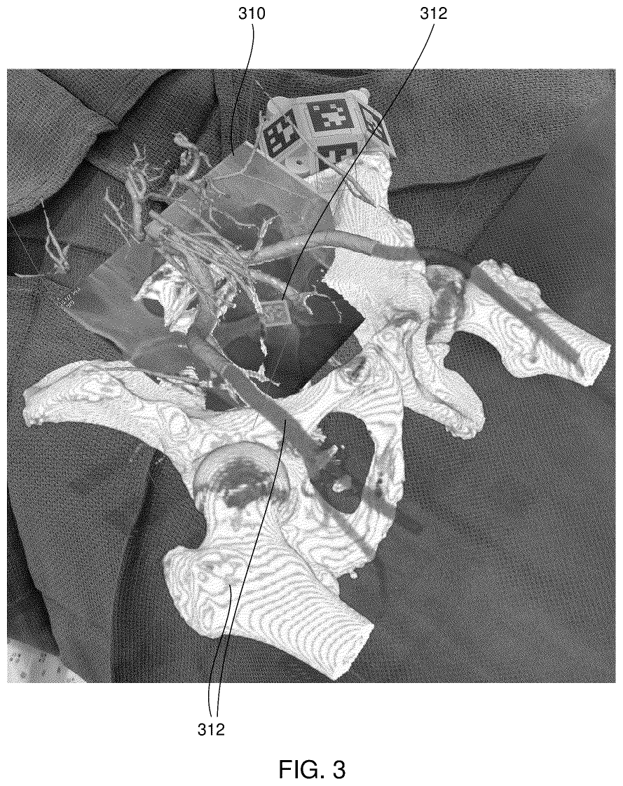

FIG. 3 illustrates the alignment of a fluoroscopic image 310 with a body of a person. The grayer, flatter looking area may be the fluoroscopic image 310 or X-ray with a visible tag 312 that includes an image visible marker portion. The visible tag 312 (e.g., 2D bar code) and image visible marker portion (e.g., radiopaque material) may be on the skin of the patient. In addition, the 3D image data 312 can be aligned with a fluoroscopic image 310 in order to align with a body of a person. In this case, the 3D image data may be segments of a CT scan or MRI that can be used for angiography or blood vessel treatment. The fluoroscopic image 310 can be aligned with the body of the person using the visible tag 312 and the image visible tag portion. Then the identified anatomy (e.g., bone, organs, blood vessels, etc.) in the fluoroscopic image 310 and the 3D image data can be aligned in at least the X and Y planes.

In some surgical procedures (e.g., spinal fusion surgery), it is more important to be able to align things in the X and Y planes of the fluoroscopic image but the alignment of the depth may be less critical. For example, if a surgeon is performing an operation and it is most important to be able to align with the pedicles in the spine then the highest accuracy may be desired in the X and Y plane of the fluoroscopic image. The depth of the fluoroscopic image and the 3D data set may be less critical as long as the pedicle screws are properly placed in the right X and Y location of the spine, because the length of the pedicle screws themselves can be used to govern the depth the screws travel. A less accurate depth position or alignment can be roughly lined up by aligning a slice of the 3D image data with a silhouette of the person's body, skin or external anatomy in the depth axis. For example, the depth can be roughly aligned from a lateral view of the patient. The depth may need to be roughly aligned or accurately aligned because when a fluoroscopic image is captured, the fluoroscopic image (e.g., x-ray) location could be anywhere from the x-ray source emitter to the x-ray detector.

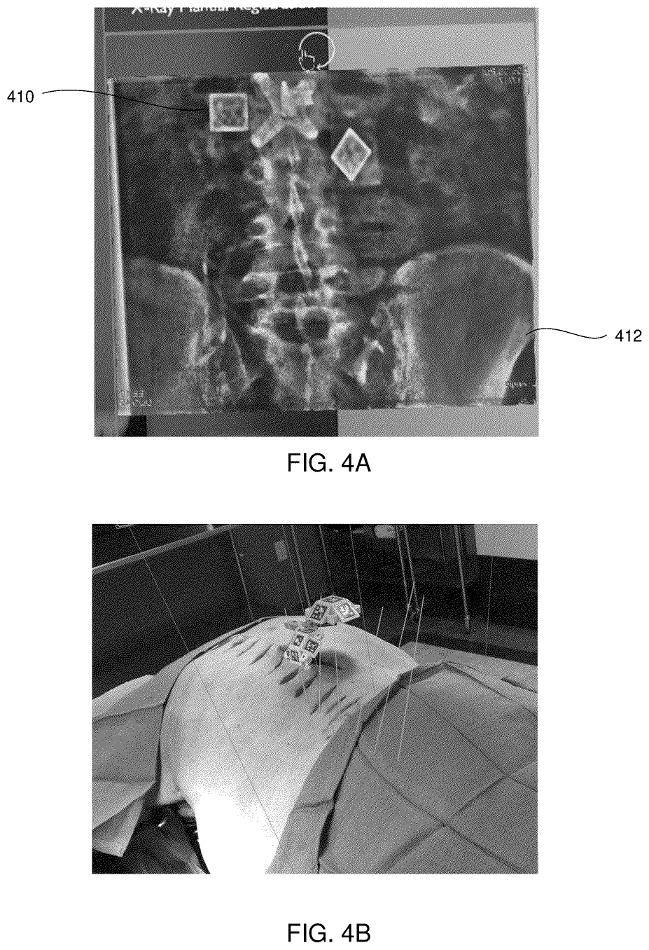

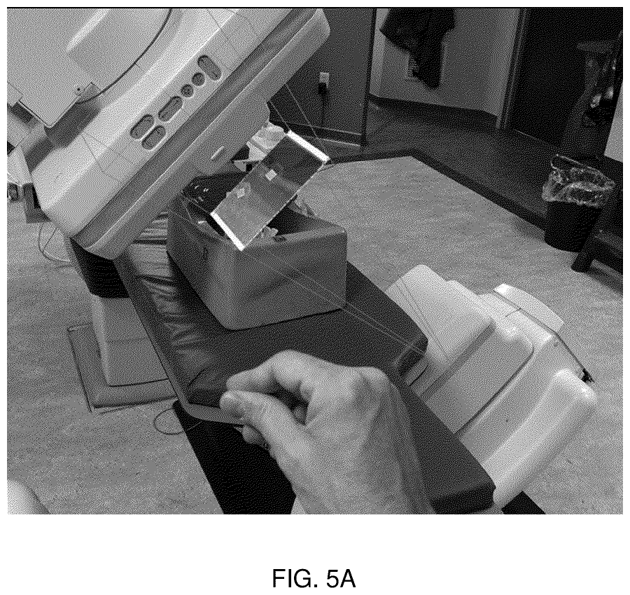

FIG. 4A illustrates a fluoroscopic image 410 and a CT scan 412 that are aligned using an internally identifiable portion of anatomical structure in the slice of the CT scan that aligns with an internally identifiable portion of the anatomical structure in the fluoroscopic image. The term internally identifiable may include internal anatomical structure that cannot normally be seen outside of a person's skin and in contrast to an outer layer of a person (e.g., skin or external landmarks or features). For example, a medical professional may take an AP x-ray and set it to be a first color (e.g., green). Then a slice of a CT scan that has a common anatomical structure may be set to another color (e.g., pink). The medical professional may align the slice and fluoroscopic image 410 so the common anatomical structure in the two images is matched. The alignment may take place using a visual alignment with manual input or the alignment could occur with automatic data fitting.

FIG. 4B illustrates a body of a cadaver with at least two optical codes with image visible markers fixed into the spine with which a user may capture at least two fluoroscopic images at separate non-parallel angles. The doctor may use an optical code that is attached to a metal tracker and provides a reference point in space for the fluoroscopic image.

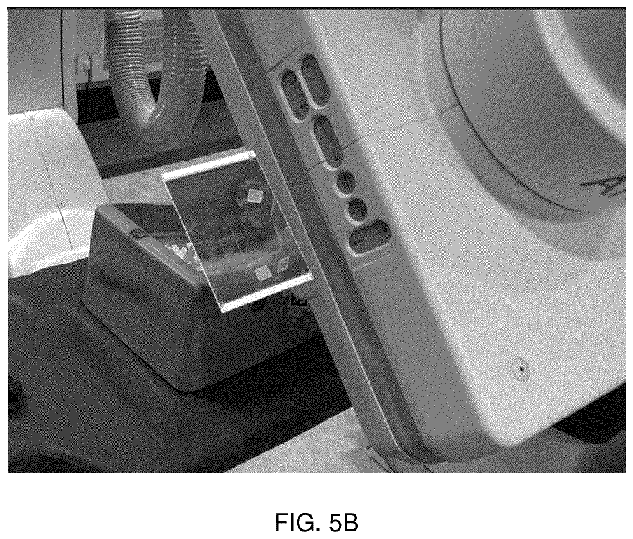

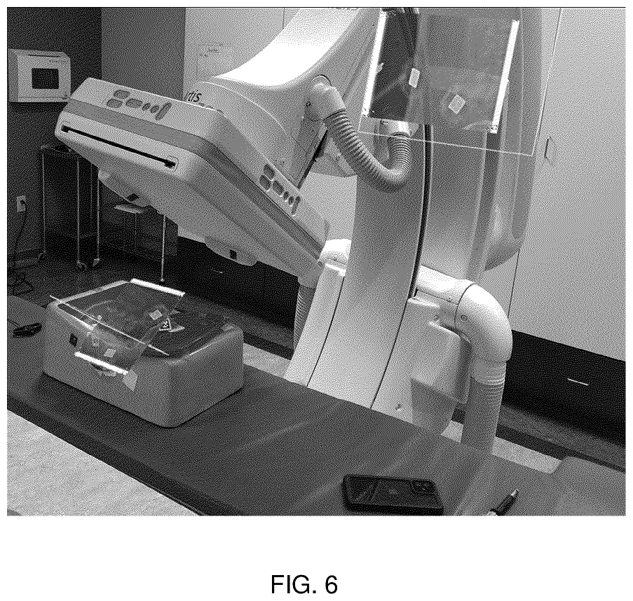

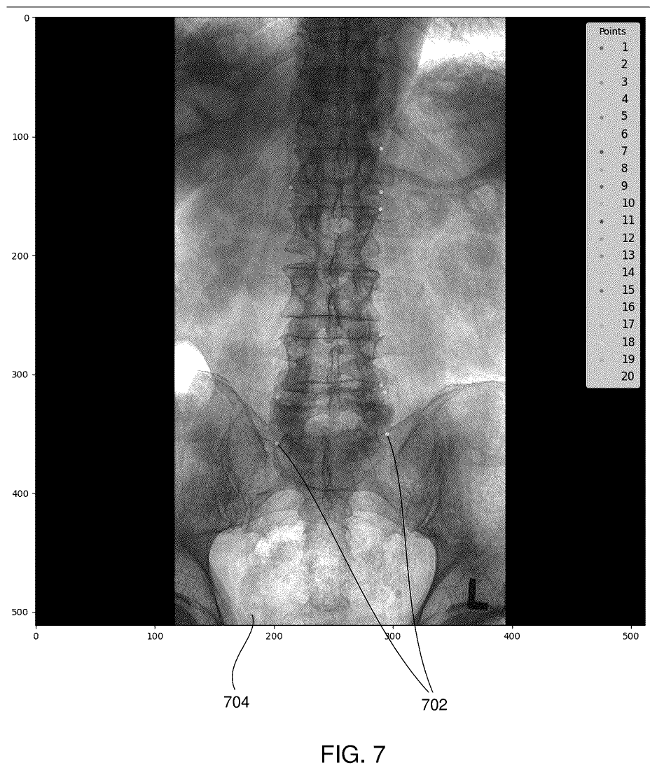

FIG. 5A illustrates a fluoroscopic image taken from a first position for a simulated anatomical object. FIG. 5B illustrates a fluoroscopic image taken from a second position or angle for the simulated anatomical object in FIG. 5A. FIG. 6 illustrates that a first fluoroscopic image and second fluoroscopic image taken from separate angles may intersect at a location. The two fluoroscopic images may intersect when they are aligned using common anatomy that is marked in both fluoroscopic images to identify a depth point for the two fluoroscopic images.

In addition to aligning the 3D image data with internal anatomical structure in two axes, alignment may also occur in a third axis to complete the alignment in three dimensions, as discussed earlier. An additional operation may be obtaining a second fluoroscopic image from a second axis using a second image visible marker. A second slice of the 3D image may be presented that is substantially parallel to the second fluoroscopic image. The movement of the second slice of the 3D image data may be limited with respect to the second axis so the slice cannot move in the depth direction. Adjustments to the second slice that are orthogonal to the second axis may be received until an internally identifiable portion of anatomical structure in the slice aligns with an internally identifiable portion of the anatomical structure of the second fluoroscopic image of the person as viewable from a perspective of the wearable display device, an AR headset aligned with the second axis or a 2D display, in order to align the 3D image data with the person.

Another way in which a third axis or depth of 3D image data can be aligned is by using edges of anatomical structure in a fluoroscopic image and/or 3D image data set. Specifically, alignment between edges of the anatomical structure in a slice of the 3D image data and edges of the anatomical structure of the person may be detected by using an edge detection process to determine when the anatomical structure in the first fluoroscopic image aligns with anatomical structure in a CT scan. For example, an additional slice of the 3D image data can be displayed orthogonal to an additional axis, which is identified from a plurality of pre-defined axes of the 3D image data. Movement of the slice in the depth direction can be limited with respect to the additional axis. Adjustments to the slice can then be received that are orthogonal to the additional axis until an edge of the anatomical structure in the slice aligns with an edge of the anatomical structure of the person as detected from a perspective of an AR headset or other display, to align the 3D image data with the person.

One example of this process may include identifying the 3D image data, having a plurality of pre-defined axes, in proximity of the anatomical structure of the person. The 3D image data may be in proximity to a person that may be undergoing a procedure. Alternatively, the 3D image data may be located anywhere in the 3D coordinate system of the AR headset. The 3D image data may be dragged by the user (e.g., medical personnel) of the AR headset into the proximity of the person's anatomical structure. For example, the anatomical structure may be the person's head. This may be considered a starting point for the alignment process. If desired, the 3D image data may even be roughly or inaccurately placed on the anatomical structure of the person or patient.

A slice of the 3D image data orthogonal to an axis may be identified using the pre-defined axes. The slice selected may be along an axis that is selected from the pre-defined axes. For example, the pre-defined axes of the 3D image data set may be the sagittal, axial, and coronal axes of a person's anatomy in the 3D image data. Other medical axes of the person's body can also be used such as the transverse axis or plane, frontal axis (similar to axial) or plane, longitudinal axis, oblique axes, etc. depending on the desired axes or planes to be used and/or the anatomical structure being viewed. The technology may present views of the anatomy in three different orthogonal axes.

Using the defined axes or medically defined axes of a person's body, the technology can enable a slice to be restricted in movement or locked on the selected axis and adjusted in the remaining orthogonal axes to the selected axis where the image is locked. Other axes that are not well known medical axes can be selected (e.g., a selected oblique axis) and these axes may be orthogonal to each other for use in the present technology. For example, the slice of the 3D image data may be sliced orthogonal to the selected axis and then the slice on the axis can be locked in the depth axis for the user's current perspective. A slice may be one or a few voxels wide from the 3D image data. The 3D image data and slice may be direct volume rendered and/or represent a 3D volume of anatomy scanned by a medical imaging device. In addition, the 3D image data may be a computed tomography (CT) scan or MRI (magnetic resonance imaging) image.

A slice of the 3D image data may be automatically identified that has a probability of matching the anatomical structure of the person viewed through the AR headset or detected from a position of the AR headset. The slice selected may be selected using AI or machine learning. Rule based implementations or pattern matching may also be used to select the slice. For example, a slice automatically selected may be anatomical structure in the image data set that has a widest diameter (widest diameter of the head, heart, torso or kidney) of the anatomical structure orthogonal to the axis of the 3D image data. In another example, a slice may be automatically selected that has a greatest total cross sectional area of the anatomical structure being selected (e.g., the nose on the head, the hand, the arm, the bone, etc.). In another example, a process may pick the slice with maximum extension from a cylindrical area of the anatomical structure (e.g., a nose from head, a widest or fattest part of the body, etc.).

When selecting a slice, the user may want to select a slice where that anatomical structure being aligned is the widest or thickest because the 3D image data may be projected over the anatomical structure. The user may not be able to see anatomical structure that is covered by the projected 3D image data in the AR headset but having a wide slice may assist with better silhouette alignment.

The process of aligning a slice of 3D image data to a fluoroscopic image may be repeated on multiple axes. For example, the operations of displaying the slice, locking the slice in the depth direction and receiving adjustments to the 3D image data can be performed for two or more additional axes. The system may use pre-defined axes such as the sagittal, axial, and coronal axes of a person's anatomy in the 3D image data. However, other axes may be used as desired.

FIG. 7 illustrates that one or more anatomical landmarks 702 (e.g., anatomical structures) may be identified in a fluoroscopic image using machine learning. A corresponding anatomical landmark may also be identified in a slice of the 3D image data using machine learning. The slice of the 3D image data may be parallel to the fluoroscopic image. Machine learning may be used to provide adjustments to a slice of the 3D image data until anatomical landmarks align with internally identifiable portions of anatomical structure or anatomical landmarks 702 shown in a fluoroscopic image. Then the slice of the 3D image data can be aligned with the fluoroscopic image after aligning the anatomical landmark(s) or anatomical structures in the fluoroscopic image with the corresponding anatomical landmarks in the slice of the 3D image data.

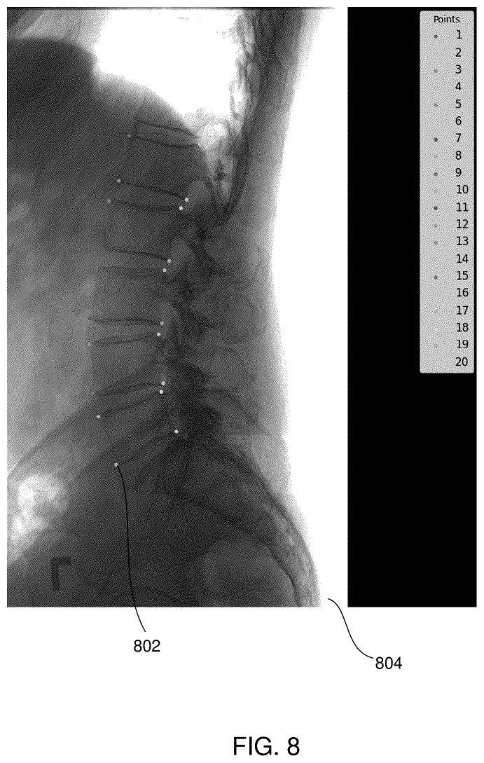

FIG. 8 illustrates an anatomical landmark 802 in a lateral fluoroscopic image 804 which may be identified using machine learning. The process described with respect to FIG. 7 can also be repeated for this lateral fluoroscopic image. Using the lateral fluoroscopic image can also provide an additional axis to align the 3D image data to the body of the patient or person resulting in alignment in all three dimensions of space.

Another method for aligning the 3D image data in a depth dimension may be to use a radiopaque marker in the fluoroscopic image. More specifically, a size of image visible marker or a radiopaque object can be used for determining a depth of the fluoroscopic image on an axis (e.g., an axis viewable from the wearable display device or an AR headset). Once the depth axis is set for the fluoroscopic image then the 3D image data can be aligned to the fluoroscopic image.

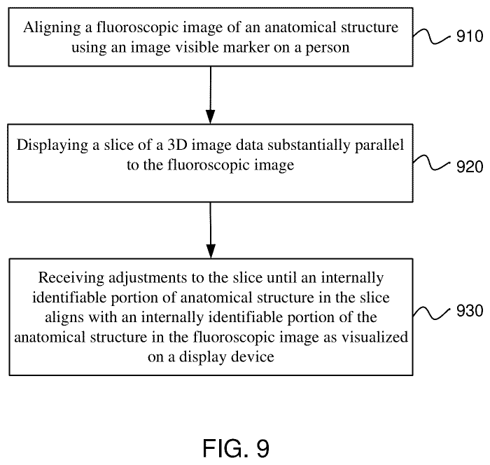

FIG. 9 is a flowchart illustrating a method for aligning the 3D image data with anatomy of the person. One operation in the method may be aligning a fluoroscopic image of an anatomical structure using an image visible marker on a person, as in block 910

A slice of a 3D image data may be displayed substantially parallel to the fluoroscopic image, as in block 920. Adjustments to the slice may be received until an internally identifiable portion of anatomical structure in the slice aligns with an internally identifiable portion of the anatomical structure in the fluoroscopic image as visualized on a display device, as in block 930. The movement of the slice may be limited with respect to a first axis that aligns with the x-rays used to capture the fluoroscopic image. The stops the slice from being moved in the depth direction while being aligned in the X and Y directions. This process can also be repeated for another axis (e.g., the depth axis).

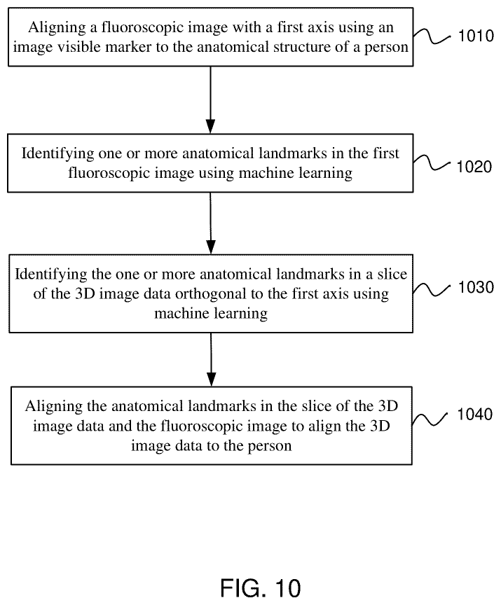

FIG. 10 is an example flowchart illustrating a method for aligning a 3D image data set with an anatomical structure of a person. A fluoroscopic image with a first axis may be aligned using an image visible marker to the anatomical structure of a person, as in block 111010. Another operation can be identifying one or more anatomical landmarks in the fluoroscopic image using machine learning, as in block 1120.

The one or more anatomical landmarks can be identified in a slice of the 3D image data orthogonal to the first axis using machine learning, as in block 1030. These anatomical landmarks may be common to both the slice of the 3D image data and the fluoroscopic image.

The anatomical landmarks in the slice of the 3D image data and the fluoroscopic image can be aligned in order to align the 3D image data to the person, as in block 1040. In an example of the method in FIG. 10, a medical professional can align a fluoroscopic image (e.g., an x-ray) with a projected slice of a CT scan using the machine learning identified anatomical landmarks (in an MRI or similar machine captured image) with a portion of a person's body (e.g., a patient).

The machine learning can be used by aligning a second fluoroscopic image on a second axis using a second image visible marker on the body of the person. Anatomical landmarks (e.g., points or areas) in the second fluoroscopic image can be identified using machine learning. Then anatomical landmarks in a second slice of the 3D image data can be identified, that is orthogonal to the second axis using machine learning. The anatomical landmarks in the second slice of the 3D image data and the second fluoroscopic image can be aligned in order to align the 3D image data to the anatomical structure of the person in a second axis. The anatomical landmarks may be identifiable anatomy of the bones, other tissue, or organs that can be identified in the fluoroscopic image and the slice of the 3D image data. For example, anatomical landmarks may be identified in the AP x-rays or lateral x-rays. When the anatomical landmarks (e.g., points or segments) are found in a fluoroscopic image using AI, then the segment can be labeled. Those same segments can be found in a slice or projection of a CT scan. Finally, those anatomical landmarks can be co-registered automatically or by receiving user input.

In another embodiment, a second fluoroscopic image can be obtained from a second axis using a second image visible marker. The movement of the slice may be limited with respect to the second axis. Adjustments to the slice that are orthogonal to the second axis may be received until an internally identifiable portion of anatomical structure in the slice aligns with an internally identifiable portion of the anatomical structure of the person as detected from a perspective of a user or an AR headset aligned with the first axis, in order to align the 3D image data with the person. As discussed earlier, the slice of the 3D image data is obtained by obtaining a projection of the 3D image data set captured prior to a medical procedure for the person. The one or more anatomical landmarks may be an anatomical segment, such as a bone or organ segment, identified by the machine learning.

In a further configuration, an alignment between edges of the anatomical structure in the slice and edges of the anatomical structure of the person can be detected by using an edge detection process to determine when the anatomical structure in the CT scan aligns with the outer part of the patient's body.

In a more specific example, a medical professional can take a fluoroscopic image (e.g., an X-ray). 3D image data may exist and the medical professional may want to register the 3D image data to the patient. The medical professional or doctor can provide a rough alignment for the 3D image data by looking at the silhouette of the skin or body the patient through the AR headset. Then a more accurate alignment can be made by identifying internal anatomy like the spine in a projected slice of the 3D image data (e.g., a pseudo X-ray image from the CT scan) and then a fluoroscopic image may be taken of the internal anatomy. This fluoroscopic image may be an AP (Anterior Posterior) x-ray where the x-rays travel from the back of the patient down through the front of the patient to an x-ray detector. The vertebral segments can be seen on both the fluoroscopic image(s) and the vertebral segments can be seen in the CT scan. The visible bones can be aligned using pattern recognition, AI, edge detection or manually. For example, if the AI finds anatomical landmarks or anatomical segments, these structures can be aligned by aligning dots or colored images so the identified features are superimposed on each other. In addition, there is an optical tracker on the skin of a patient with an image visible marker to enable the fluoroscopic image to be aligned with the body of the person and for the wearable display device or AR headset to record, as discussed earlier. The optical tracker allows the registration of the image to be maintained.

There are at least three ways that a full alignment of a 3D data set could take place. There are also some ways that a partial alignment could occur in two planes and also be useful.
1. The first method of full alignment may be to capture a fluoroscopic image (e.g., an AP X-ray) and align a slice of the 3D image data with the fluoroscopic image. So, when the anatomical structures in both the fluoroscopic image and the slice align using input received from a user, then the 3D data set can be aligned in two axes (e.g., X and Y) using internal anatomical structures common to the fluoroscopic image and the 3D data set. Then in order to perform an alignment in a third axis (e.g., the Z or depth direction) the medical professional can rotate the x-ray beam and identify an optical marker with an image visible marker that is at another angle (e.g., 45 or 90 degrees) to a first axis that was used for taking the first fluoroscopic image (and a first optical code). So, when the medical professional rotates the fluoroscopic image device and shoots another x-ray, then the medical professional has a 3 dimensional fluoroscopic image (e.g., x-ray) data set. Then a slice of the 3D data set that is parallel to the second fluoroscopic image can be aligned for the third axis by receiving input from a user to align corresponding internal anatomical structures of the 3D data set and the fluoroscopic image. So, when slices of the 3D data set are aligned in the 2 non-parallel planes then the image is aligned three dimensions.
2. A second method for full alignment is where the medical professional can take a single frontal or back fluoroscopic image (e.g., x-ray). The fluoroscopic image may have a slice of the 3D image data aligned with the fluoroscopic image in two axes (e.g., a relative X and Y) using corresponding internal anatomical structures of the 3D data set and the fluoroscopic image and input received from a user or an AI. Then the third axis (e.g., the depth) can be aligned by using a silhouette of the person. In other words, the medical professional can look at the lateral side of the patient using a wearable display or AR headset, and align the shape of the skin, spine or other visible outside anatomy to the skin, spine or other visible outside anatomy in the CT scan or MRI. This allows a medical professional to the align the anatomy as the anatomy exists on the surgical table in the depth direction. In a specific example, the X and Y plane may be more useful than the depth plane, if the medical professional is trying to target the pedicles in the spine.
3. In a third method for full alignment, at least two fluoroscopic images may be captured that each have an optical code with an image visible code. Machine learning may be used on the fluoroscopic image (e.g., X-ray) to find anatomical structures that are anatomic landmarks. Such anatomical landmarks can be the vertebral bodies, spinous processes, Iliac crests, ribs, organs, spaces between structures, etc. Machine learning may be used find the same anatomical points in a slice of a CT scan, and the fluoroscopic images and slices of the 3D data set can be aligned by aligning the anatomic landmarks or with data fitting. This type of alignment may occur for a third axis.

A partial alignment may be created by aligning a slice of the 3D data set to a fluoroscopic image so that alignment occurs in one plane. This alignment may be done by aligning anatomical structure in the slice and fluoroscopic image found by machine learning. Alignment may also be done by receiving input from a user to align the 3D data with fluoroscopic image.

In another partial alignment embodiment, a doctor can align a slice of a 3D data set with a silhouette of a person. The doctor can see where the surface of the patient is for a less accurate alignment. Then the doctor can perform a more accurate registration using a fluoroscopic image (e.g., X-ray) with an optical tag that has an image visible component. This allows the doctor to align the internal anatomy (e.g., bone-to-bone) that is common between the slice of the 3D data set and the fluoroscopic image. This process may be used on a single fluoroscopic image from the back of the patient. This allows for good alignment in two axes (e.g., X and Y). The depth alignment (Z alignment) may not be good but the software or the doctor can use the size or zoom of the radiopaque tag that is known in advance to determine the depth of the fluoroscopic image.

To reiterate and summarize, the present technology is configured to align a 3D data set onto a patient. Alignment can take place if there are fiducials on the patient, like image visible tags that have optical codes or image visible tags that are shaped to be recognized by an AR headset. It may be that the patient comes in an operating room (OR) and has no fiducials on the patient. Landmarks on the patient or other morphometric measurements may be used for alignment but this is not as accurate for anatomical structure that cannot be seen, like deep in the spine. So, the 3D data set (e.g., the CT scan) can be aligned using the internal anatomy of the patient, such as the anatomical structure of the spine. The spine can be detected in a fluoroscopic image (e.g., x-ray) and in a slice of the 3D data set (e.g., the CT scan) and the images can be aligned. The patient may be on an operating table with an optical tag and an image visible marker on the patient. A fluoroscopic image (e.g., x-ray) may be captured that includes the position of the marker with its image visible component. The fluoroscopic image can be aligned to the patient using the image visible marker using an AR headset or other wearable display. Then the 3D data set (e.g., CT scan or MRI image) can be automatically or manually aligned to the fluoroscopic image using anatomical landmarks identified by machine learning. To be able to align in three dimensions using this example technique, at least two non-parallel fluoroscopic images (e.g., x-rays) are needed from at least two angles. The two different non-parallel projections do not have to be at 90 degrees. When a slice of the 3D data set (e.g., CT scan) is aligned with a fluoroscopic image in a first orientation and another slice is aligned using an additional angle, then the 3D data set will be aligned in three dimensions with the body of the person.

As discussed earlier, the alignment between the fluoroscopic image and the slice of the 3D data set may be aligned manually. The doctor see can the bones on the slice of the CT scan and the doctor can drag the slice until the internal anatomical structure matches the internal anatomical structure in the x-ray that is common to both images. Alternatively, the doctor can perform a combination of items where the doctor can drag the slice of the 3D data set to align with the x-ray in one view but use the surface of the patient's body or landmarks of the patient to align a slice of the 3D data set in another view. Furthermore, the doctor may use any combination of data fitting using machine learning along with manual alignment.

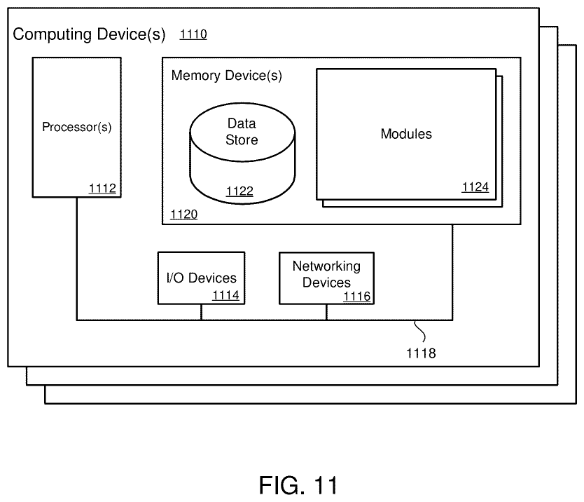

FIG. 11 illustrates a computing device 1110 on which modules of this technology may execute. The computing device 1110 is illustrated on which a high level example of the technology may be executed. The computing device 1110 may include one or more processors 1112 that are in communication with memory devices 1120. The computing device may include a local communication interface 1118 for the components in the computing device. For example, the local communication interface may be a local data bus and/or any related address or control busses as may be desired.

The memory device 1120 may contain modules 1124 that are executable by the processor(s) 1112 and data for the modules 1124. The modules 1124 may execute the functions described earlier. A data store 1122 may also be located in the memory device 1120 for storing data related to the modules 1124 and other applications along with an operating system that is executable by the processor(s) 1112.

Other applications may also be stored in the memory device 1120 and may be executable by the processor(s) 1112. Components or modules discussed in this description that may be implemented in the form of software using high programming level languages that are compiled, interpreted or executed using a hybrid of the methods.

The computing device may also have access to I/O (input/output) devices 1114 that are usable by the computing devices. An example of an I/O device is a display screen that is available to display output from the computing devices. Other known I/O device may be used with the computing device as desired. Networking devices 1116 and similar communication devices may be included in the computing device. The networking devices 1116 may be wired or wireless networking devices that connect to the internet, a LAN, WAN, or other computing network.

The components or modules that are shown as being stored in the memory device 1120 may be executed by the processor 1112. The term “executable” may mean a program file that is in a form that may be executed by a processor 1112. For example, a program in a higher level language may be compiled into machine code in a format that may be loaded into a random access portion of the memory device 1120 and executed by the processor 1112, or source code may be loaded by another executable program and interpreted to generate instructions in a random access portion of the memory to be executed by a processor. The executable program may be stored in any portion or component of the memory device 1120. For example, the memory device 1120 may be random access memory (RAM), read only memory (ROM), flash memory, a solid state drive, memory card, a hard drive, optical disk, floppy disk, magnetic tape, or any other memory components.

The processor 1112 may represent multiple processors and the memory 1120 may represent multiple memory units that operate in parallel to the processing circuits. This may provide parallel processing channels for the processes and data in the system. The local interface 1118 may be used as a network to facilitate communication between any of the multiple processors and multiple memories. The local interface 1118 may use additional systems designed for coordinating communication such as load balancing, bulk data transfer, and similar systems.

Many types of 3D image data can be aligned to the body of the person or be aligned to the body of the person using a marker or other alignment systems. Medical imaging may be obtained and aligned with a body of a person. For example, a CT (computed tomography) scan, MRI (magnetic resonance imaging) image or other imaging may be overlaid on the patient and used as a reference for aspects of a patient's anatomical structure being operated on. U.S. Pat. Nos. 9,892,564; 10,475,244; 11,004,271; 10,010,379; 10,945,807; 11,266,480; 10,825,563; 11,237,627; 11,287,874; U.S. patent application Ser. No. 17/706,462 entitled “Using Optical Codes with Augmented Reality Displays”; and U.S. patent application Ser. No. 17/536,009 entitled “Image Data Set Alignment for an AR Headset Using Anatomic Structures and Data Fitting”; and U.S. patent application Ser. No. 17/978,962 entitled “3D Spatial Mapping in a 3D Coordinate System of an AR Headset Using 2D Images” describe related information for methods and systems for aligning an image data set from medical imaging devices with a body of a person and these descriptions are incorporated in their entirety by reference herein to further explain aspects of the technology. These incorporated patents and patent applications also describe a wide variety of medical imaging types that may be used to obtain 3D image data sets.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method, comprising:
aligning a fluoroscopic image of an anatomical structure using an image visible marker on a person;
displaying a slice of a 3D image data substantially parallel to the fluoroscopic image; and
receiving adjustments to the slice until an internally identifiable portion of anatomical structure in the slice aligns with an internally identifiable portion of the anatomical structure in the fluoroscopic image as visualized on a display device, in order to align the 3D image data with anatomy of the person.

2. The method as in claim 1, further comprising limiting movement of the slice with respect to a first axis.

3. The method as in claim 1, further comprising:
capturing the fluoroscopic image using x-rays in a first axis; and
receiving adjustments to the slice that are substantially orthogonal to the first axis.

4. The method as in claim 1, further comprising:
obtaining an additional fluoroscopic image having a second axis using an additional image visible marker;
limiting movement of an additional slice of the 3D image data in the depth direction with respect to the second axis; and
receiving adjustments to the additional slice that are orthogonal to the second axis until an internally identifiable portion of anatomical structure in the slice aligns with an internally identifiable portion of the anatomical structure of the person as detected from a perspective of a wearable display device or an AR headset aligned with the second axis, to align the 3D image data with the person.

5. The method as in claim 1, further comprising:
identifying an anatomical landmark in the fluoroscopic image and a corresponding anatomical landmark in the slice of the 3D image data using machine learning; and
aligning the slice of the 3D image data with the fluoroscopic image by aligning the anatomical landmark in the fluoroscopic image with the corresponding anatomical landmark in the slice of the 3D image data.

6. The method as in claim 1, wherein an alignment between edges of the anatomical structure in the slice and edges of the anatomical structure of the person are detected by using an edge detection process to determine when the anatomical structure in the fluoroscopic image aligns with anatomical structure in a CT scan.

7. The method as in claim 1, wherein the slice of the 3D image data is obtained by obtaining a projection of the 3D image data set captured prior to a medical procedure for the person.

8. The method as in claim 1, further comprising applying the adjustments to the slice to the 3D image data.

9. The method as in claim 1, further comprising repeating the displaying the slice, locking the slice and receiving adjustments to the 3D image data for two additional axes.

10. The method as in claim 1, further comprising:
displaying an additional slice of the 3D image data orthogonal to an additional axis, which is identified from a plurality of pre-defined axes of the 3D image data;
limiting movement of the slice with respect to the additional axis; and
receiving adjustments to the slice that are orthogonal to the additional axis until an edge of the anatomical structure in the slice aligns with an edge of the anatomical structure of the person as detected from a perspective of an AR headset, to align the 3D image data with the person.

11. The method as in claim 10, wherein the plurality of pre-defined axes are sagittal, axial, and coronal axes of a person's anatomy in the 3D image data.

12. The method as in claim 1, wherein a size of the image visible marker or a radiopaque object is used for determining a depth of the slice of the fluoroscopic image along a first axis that substantially aligns with an axis of x-rays used to capture the fluoroscopic image.

13. A method for aligning a 3D image data set with an anatomical structure of a person, comprising:
aligning a fluoroscopic image with a first axis to the anatomical structure of a person using an image visible marker;
identifying one or more anatomical landmarks in the fluoroscopic image using machine learning;
identifying the one or more anatomical landmarks in a slice of the 3D image data orthogonal to the first axis using machine learning; and
aligning the anatomical landmarks in the slice of the 3D image data and the fluoroscopic image to align the 3D image data to the person.

14. The method as in claim 13, further comprising:
aligning an additional fluoroscopic image on a second axis using an additional image visible marker;
identifying anatomical landmarks in the additional fluoroscopic image using machine learning;
identifying anatomical landmarks in an additional slice of the 3D image data orthogonal to the second axis using machine learning; and
aligning the anatomical landmarks in the additional slice of the 3D image data and the additional fluoroscopic image to align the 3D image data to the anatomical structure of the person.

15. The method as in claim 13, further comprising:
obtaining an additional fluoroscopic image from a second axis using an additional image visible marker;
limiting movement of the slice with respect to the second axis; and
receiving adjustments to the slice that are orthogonal to the second axis until an internally identifiable portion anatomical structure in the slice aligns with an internally identifiable portion of the anatomical structure of the person as detected from a perspective of an AR headset aligned with the first axis, to align the 3D image data with the person.

16. The method as in claim 13, wherein the slice of the 3D image data is obtained by obtaining a projection of the 3D image data set captured prior to a medical procedure for the person.

17. The method as in claim 13, wherein an alignment between edges of the anatomical structure in the slice and edges of the anatomical structure of the person are detected by using an edge detection process to determine when the anatomical structure in the fluoroscopic image aligns with anatomical structure in a CT scan.

18. The method as in claim 13, wherein the one or more anatomical landmarks are an anatomical segment identified by the machine learning.

19. The method as in claim 13, wherein a size of the image visible marker or a radiopaque object is used for determining a depth of the fluoroscopic image on the first axis from a wearable display device or an AR headset.

20. A system for aligning a 3D image data with an anatomical structure of a person, the system comprising:
at least one processor;
at least one memory device including a data store to store a plurality of data and instructions that, when executed, cause the system to:
aligning a first fluoroscopic image of the anatomical structure of the person captured from a first axis using a first image visible marker on the person;
displaying a slice of the 3D image data orthogonal to the first axis; and
receiving adjustments to the slice that are orthogonal to the first axis until an internally identifiable portion of anatomical structure in the slice aligns with an internally identifiable portion of the anatomical structure in the first fluoroscopic image as detected from a perspective of a wearable display device aligned with the first axis, in order to align the 3D image data with the person.

21. The system as in claim 20, further comprising limiting movement of the slice with respect to the first axis.

22. The system as in claim 20, further comprising:
obtaining an additional fluoroscopic image from a second axis using an additional image visible marker;
limiting movement of an additional slice of the 3D image data with respect to and orthogonal to the second axis; and
receiving adjustments to the additional slice that are orthogonal to the second axis until an internally identifiable portion of anatomical structure in the slice aligns with an internally identifiable portion of the anatomical structure of the person as detected from a perspective of the wearable display device or an AR headset aligned with the second axis, to align the 3D image data with the person.

23. The system as in claim 20, further comprising:
identifying an anatomical landmark in the first fluoroscopic image and a corresponding anatomical landmark in the slice of the 3D image data using machine learning; and
aligning the slice of the 3D image data with the first fluoroscopic image by aligning the anatomical landmark in the first fluoroscopic image with the corresponding anatomical landmark in the slice of the 3D image data.
